(19) United States
(12) Patent Application Publication
(10) Pub. No.: US 2026/0098503 A1
(43) Pub. Date: Apr. 9, 2026

(54) FUEL QUANTITY MONITORING USING FUEL RAIL PRESSURE

(71) Applicant: Caterpillar Inc., Peoria, IL (US)

(72) Inventors: Payton M. JOHNSON, Peoria, IL (US); Daniel R. PUCKETT, Peoria, IL (US)

(73) Assignee: Caterpillar Inc., Peoria, IL (US)

(21) Appl. No.: 18/909,751

(22) Filed: Oct. 8, 2024

(51) Int. Cl. F02D 41/22

(52) U.S. Cl. CPC F02D 41/221; F02D 2041/226

(57) ABSTRACT

A system for determining fuel delivery includes an internal combustion engine having a plurality of cylinders, a plurality of fuel injectors configured to inject fuel for combustion in the cylinders, a fuel rail configured to provide the fuel to the plurality of fuel injectors, and a fuel pump configured to pressurize the fuel provided to the fuel rail. The system also includes a pressure sensor configured to detect a pressure of the fuel within the fuel rail and a controller configured to receive a pressure signal that indicates the pressure of the fuel detected with the pressure sensor, the pressure signal including pressure fluctuations caused by the fuel pump, and determine a quantity of the fuel injected by one or more fuel injectors of the plurality of fuel injectors, wherein the determination includes removing or reducing at least some of the pressure fluctuations caused by the fuel pump.

### TECHNICAL FIELD

The present disclosure relates generally to internal combustion engines, and more particularly, to a system for monitoring fuel injection in an internal combustion engine.

### BACKGROUND

Internal combustion engines are used in various types of machines, including mobile machines and stationary machines, to generate electrical power, provide power for propulsion, and operate implements. Internal combustion engines for industrial machines, in particular, generate power for long periods of time at high output levels by combusting fuel supply via a fuel system. Over time, components of a fuel system can wear or even fail. In particular, fuel pumps and fuel injectors of the fuel system are periodically replaced.

Catastrophic fuel system failures are rare and relatively easy to recognize. Irregularities, diminished performance, or relatively minor failures in fuel systems, however, can be challenging to identify and diagnose. As a result, engine systems sometimes perform in a sub-optimal manner for extended periods of time. In some situations, even when a performance issue is apparent, it is challenging to identify the component causing the performance issue. As a result, repair or maintenance is sometimes performed on the incorrect component, or repair or maintenance involves unnecessary resources (e.g., time, parts, etc.). In some situations, minor issues can persist without detection, causing more significant and/or costly failures that can lead to machine downtime and increased repair costs.

A controller for an internal combustion engine is described in JP Patent Application Publication No. 2019-060279 (the '279 publication) to Ishikawa. The controller described in the '279 publication is configured to estimate a degree of wear and determine a replacement timing of a fuel injector based on the degree of wear. The controller described in the '279 publication estimates the degree of wear by multiplying a number of fuel injections by a common rail pressure. The controller described in the '279 publication does not monitor fuel injection in a manner that takes fluctuations in fuel rail pressure into account.

The methods and systems of the present disclosure may solve one or more of the problems set forth above and/or other problems in the art. The scope of the protection provided by the present disclosure, however, is defined by the attached claims, and not by the ability to solve any specific problem.

### SUMMARY

In one aspect, a system for determining fuel delivery may include an internal combustion engine having a plurality of cylinders, a plurality of fuel injectors configured to inject fuel for combustion in the cylinders, a fuel rail configured to provide the fuel to the plurality of fuel injectors, and a fuel pump configured to pressurize the fuel provided to the fuel rail. The system may also include a pressure sensor configured to detect a pressure of the fuel within the fuel rail and a controller configured to receive a pressure signal that indicates the pressure of the fuel detected with the pressure sensor, the pressure signal including pressure fluctuations caused by the fuel pump, and determine a quantity of the fuel injected by one or more fuel injectors of the plurality of fuel injectors, wherein the determination includes removing or reducing at least some of the pressure fluctuations caused by the fuel pump.

In another aspect, a system for determining fuel delivery may include a fuel pressure sensor configured to output a pressure signal that indicates a pressure of fuel within a fuel rail and a controller. The controller may be configured to determine a desired amount of fuel to be injected by a first fuel injector, receive the pressure signal from the fuel pressure sensor, and identify a change in pressure indicated in the pressure signal, the change in pressure corresponding to an actual amount of fuel injected by the first fuel injector. The controller may further be configured to compare the actual amount of fuel injected by the first fuel injector to the desired amount of fuel to be injected by the first fuel injector and identify a health of the first fuel injector based on the comparison.

In yet another aspect, a method for determining fuel delivery may include receiving, from a pressure sensor, a pressure signal that indicates the pressure of fuel within a fuel rail, determining a processed pressure signal that reduces or eliminates at least some pressure fluctuations in the processed signal, the pressure fluctuations being introduced by a fuel pump, and identifying a change in pressure indicated in the processed pressure signal, the change in pressure corresponding to an injection of fuel. The method may further include determining a quantity of fuel injected by one or more fuel injectors of a plurality of fuel injectors based on the identified change in pressure.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram of a fuel delivery determining system, according to aspects of the disclosure.

FIG. 2 is a block diagram of a controller of the fuel delivery determining system of FIG. 1.

FIG. 3 is a chart representing a pressure signal and a processed pressure signal that correspond to a series of crank angle positions.

FIG. 4 is a chart representing estimated fuel injection quantity and desired fuel injection quantity for over a period of time.

FIG. 5 is a chart representing pump delivery health according to fuel delivery.

FIG. 6 is a flowchart illustrating an exemplary method for determining fuel delivery.

### DETAILED DESCRIPTION

Both the foregoing general description and the following detailed description are exemplary and explanatory only and are not restrictive of the features, as claimed. As used herein, the terms “comprises,” “comprising,” “having,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value. As used herein, the phrase “based on” encompasses the phrases “based in part on” and “based entirely on.”

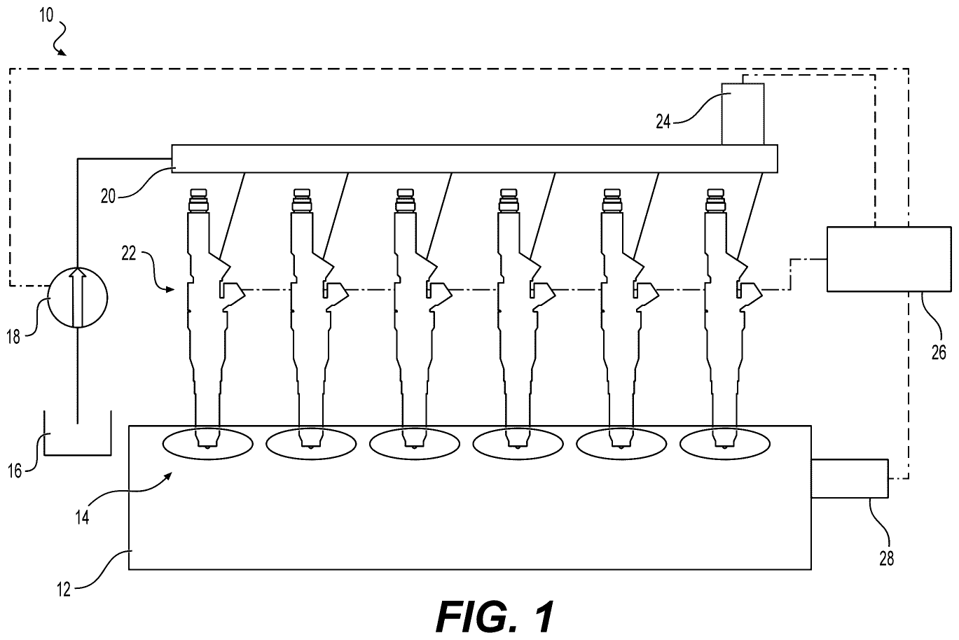

FIG. 1 is a partially-schematic diagram illustrating an internal combustion engine 12 (e.g., for an industrial machine) and a fuel delivery determining system 10. Fuel delivery determining system 10 may include components for determining a quantity of fuel injected by a fuel injector 22. In particular, fuel delivery determining system 10 may include an internal combustion engine 12, a fuel system for delivering fuel to internal combustion engine 12, and an electronic control module (ECM) 26, also referred to herein as a controller.

Internal combustion engine 12 may include a plurality of cylinders 14, six cylinders 14 being shown in FIG. 1. Internal combustion engine 12 may have any suitable number of cylinders 14, such as two, three, four, six, eight, ten, twelve, twenty, or more cylinders 14. Cylinders 14 may be arranged in a straight configuration, a V configuration, or another type of configuration known in the art. Internal combustion engine 12 may be configured for combustion of a single fuel, such as diesel fuel.

Fuel injectors 22 of the fuel delivery system for internal combustion engine 12 may be configured for direct fuel injection (as shown) or port fuel injection. Fuel injectors 22 may be common rail injectors, such as a hydraulically-actuated electronically-controlled injector. Each fuel injector 22 may be in communication with ECM 26, such that injectors 22 inject fuel in response to signals generated with ECM 26. In at least some configurations, fuel injectors 22 may be configured to injection of a liquid fuel, such as diesel fuel. Fuel injectors 22 may be configured for injection of a gaseous fuel, instead of or in addition to injection of a liquid fuel.

The fuel delivery system for engine 12 may supply pressurized fuel to each injector 22. The fuel delivery system may include a fuel source 16 (e.g., a fuel tank, sump, etc.), a fuel pump 18, and a common fuel rail 20. The fuel delivery system may also include known components such as fuel filters, pressure regulation valves, etc.

A sensor system may provide feedback to ECM 26 to allow ECM 26 to control fuel pump 18 and injectors 22. In the example shown in FIG. 1, the sensor system includes a common rail pressure sensor 24 configured to measure a pressure of fuel within common fuel rail 20 and an engine speed sensor 28 configured to measure a speed of engine 12 and output an engine speed signal. Engine speed sensor 28 may be configured to detect a position of a crankshaft of internal combustion engine 12, for example. Common rail pressure sensor 24 may be configured to detect changes in pressure of fuel within common fuel rail 20.

Fuel pump 18 may be a positive displacement pump, such as a piston pump having multiple pumping elements. Fuel pump 18 may be responsive to instructions from ECM 26. In particular, ECM 26 may be configured to generate requests or commands (e.g., signals) to control pump output. This pump output may include, for example, pump displacement, pump inlet valve metering, and/or pump outlet valve metering. Control over pump output may provide control over an output pressure from fuel pump 18. In some aspects, the pumping frequency of fuel pump 18 may correspond to the speed of internal combustion engine 12 measured with engine speed sensor 28. In particular, the pumping frequency of pump 18 may be tied to the position of a crankshaft of engine 12.

ECM 26 may be configured to receive signals from each of the sensors of the sensor system, including common rail pressure sensor 24 and engine speed sensor 28. In some configurations, ECM 26 is located on an industrial machine and is configured to monitor and control fuel injection of that machine as well as monitor the health of one or multiple components of the fuel supply system. ECM 26 may be in communication with one or more additional ECMs or other controllers for the industrial machine.

In particular, ECM 26 may encompass a single control module, or controller. As used herein, a “controller” encompasses both single controllers or control modules, or a plurality of controllers or control modules. ECM 26 may embody a single processor or multiple processors that receive inputs such as pressure change signals from common rail pressure sensor 24 and engine speed sensor 28. ECM 26 may include a memory, a secondary storage device, a processor such as a central processing unit, or any other means for accomplishing a task consistent with the present disclosure, as described below. The memory or secondary storage device associated with ECM 26 may store data and software to allow ECM 26 to perform its functions, including the functions described below with respect to method 600. Numerous commercially available microprocessors can be configured to perform the functions of ECM 26. Various other known circuits may be associated with ECM 26, including current monitoring circuitry, signal-conditioning circuitry, communication circuitry, and other appropriate circuitry.

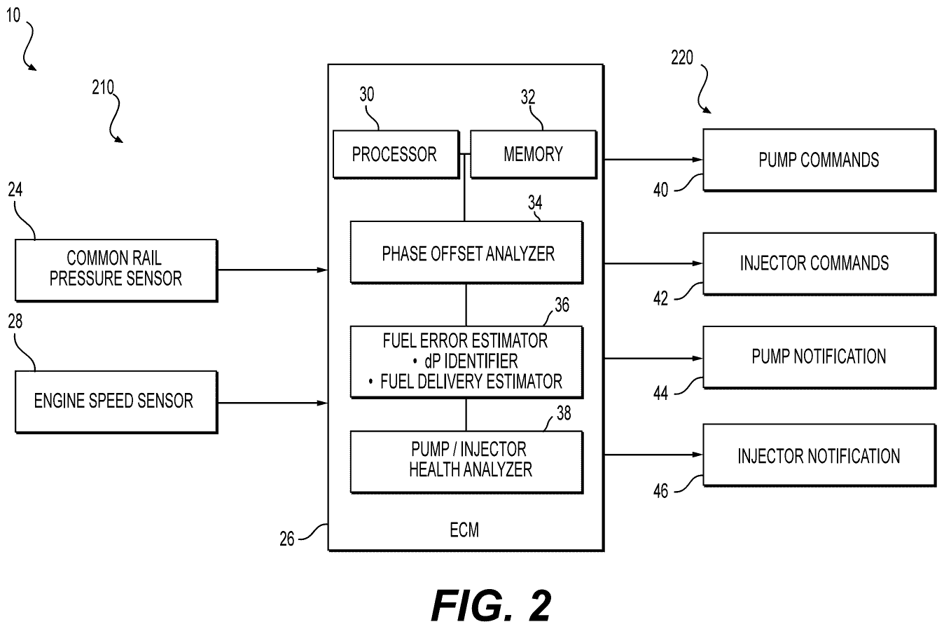

FIG. 2 is a block diagram illustrating an exemplary configuration of ECM 26. As shown in FIG. 2 and described above, ECM 26 may include one or more processors 30 and memory 32. The one or more processors 30 and memory 32 may be operable to implement a phase offset analyzer 34, a fuel error estimator 36, and a pump and/or injector health analyzer 38. One or more of the modules of ECM 26, analyzer 34, estimator 36, and analyzer 38 may receive inputs 210 and generate outputs 220 to determine the health of fuel pump 18 and fuel injectors 22 and output notifications based on the determined health.

Inputs 210 may include pressure change signals from common rail pressure sensor 24 and engine speed signals from engine speed sensor 28. Inputs 210 may further include other information related to the operation of internal combustion engine 12 and/or other components for fuel delivery determining system 10. Additional inputs 210 may include, for example, signals from temperature sensors, fuel flow sensors, airflow sensors, additional pressure sensors, and others. Inputs 210 may be received continuously or periodically while fuel delivery determining system 10 is operating.

Phase offset analyzer 34 may be configured to receive pressure change signals from common rail pressure sensor 24, as described below, which include changes in pressure that are caused by fuel pump 18, as well as changes in pressure caused by fuel injectors 22. Analyzer 34 may be configured to process the signals from sensor 24, reduce or eliminate the content of this signal that was generated by pump 18 to create a processed signal (also referred to herein as a phase-offset signal), and output the phase offset signal to fuel error estimator 36. In some examples, the phase-offset signal is a signal calculated by comparing pressure change values at different times. By generating the phase-offset signal, pressure fluctuations caused by pump 18 that are present in the pressure change signal may be removed or at least reduced.

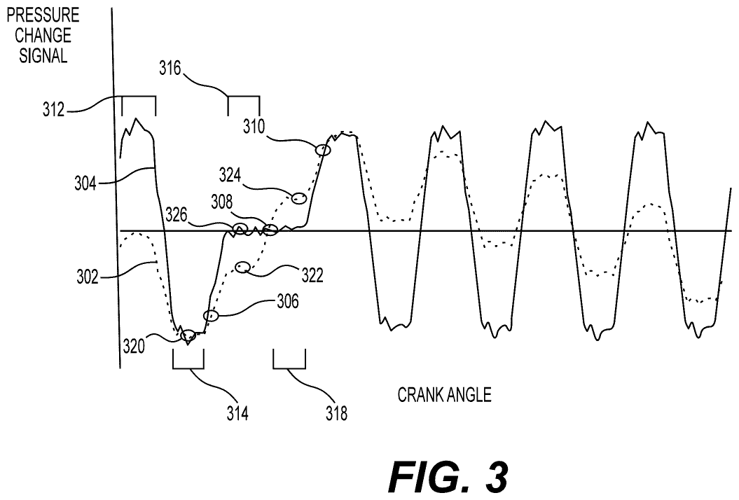

In particular, phase offset analyzer 34 of ECM 26 may be configured to process pressure signals from common rail pressure sensor 24 and also the engine speed signal from speed sensor 28. These signals may also be received and processed with fuel error estimator 36 and injector pump/injector health analyzer 38. Phase offset analyzer 34 may be configured to match a series of pressure measurements (e.g., the pressure signal, which represents changes in rail pressure over time) from sensor 24, such as magnitudes of a change in pressure, with a corresponding crankshaft position measurements, also referred to herein as “crank angle,” in the engine speed signal from sensor 28. The process of matching pressure measurements to respective crankshaft positions may generate a crank-angle-indexed pressure signal (e.g., signal 302; FIG. 3). The crank-angle-indexed pressure signal may be further processed to generate the phase-offset signal.

If desired, phase offset analyzer 34 may further be configured to filter pressure change signals (e.g., by filtering the crank-angle-indexed pressure signal). For example, the pressure signal (e.g., signal 302, representing pressure changes) may be filtered with a convolution filter. The convolution filter may apply a moving average to raw data from common rail pressure sensor 24 and engine speed sensor 28. Other filtering techniques may be applied, instead of or in addition to a convolution filter. In some embodiments, the filtering technique does not significantly alter the phase of the filtered signal.

Phase offset analyzer 34 may generate the phase-offset signal as a series of data points. To generate a point of data in the phase-offset signal, phase offset analyzer 34 may identify a reference data point in the crank-angle-indexed pressure signal. This reference data point includes a pressure change magnitude (y-axis value in FIG. 3) that is associated with a particular crank angle (x-axis value in FIG. 3). This reference data point may be compared to a pair of data points also in the crank-angle-indexed pressure signal. This pair of points may include a first data point that is advanced with respect to the reference data point and a second data point that is delayed with respect to the reference data point. In some examples, the first and second data points may be separated from the reference data point by a predetermined distance (e.g., a predetermined phase), the distance being a particular number of degrees of crank angle rotation. Based on the comparison of the reference data point with these first and second data points, analyzer 34 may generate a data point that forms part of the phase-offset signal. This process may be repeated for subsequent reference data points, to generate the entire phase-offset signal.

As described above, fuel pump 18 may pump (e.g., generate pump strokes) at a set frequency. Fuel pump 18 may generate a pulse in the pressure signal produced with common rail pressure sensor 24 each time a stroke occurs. Phase offset analyzer 34 may, when generating the phase-offset signal, reduce or eliminate the content of these pulses in the pressure signal. For example, when fuel pump 18 strokes at a rate that is equivalent to once per 60 degrees of crank angle rotation, phase offset analyzer 34 may be configured to generate a phase-offset signal based on comparison of data points that are offset by 60 degrees of crank angle rotation, by 120 degrees of crank angle rotation, or by another value, to reduce or eliminate the influence of pump 18 on the analyzed signals. The influence of pump 18 may be pressure fluctuations caused by pump 18. For example, the first data point may be advanced by 60 degrees of crank angle rotation with respect to the reference data point. The second data point may be delayed by 60 degrees of crank angle rotation with respect to the reference data point.

Fuel error estimator 36 may be configured to receive the phase-offset signal generated by phase offset analyzer 34. Fuel error estimator 36 may evaluate the signal to identify changes in pressure represented in the phase-offset signal. In some aspects, fuel error estimator 36 may identify maximum pressure values within start of injection windows and minimum pressure values within end of injection windows, as described below. A dP identifier algorithm of fuel error estimator 36 may identify the difference in pressure between pairs of maximum and minimum pressure values.

Fuel error estimator 36 may further be configured with a fuel delivery estimator to assist with identifying fuel error values. The fuel delivery estimator may estimate an actual amount of fuel that was injected during one or multiple injection events. In particular, the fuel delivery estimator may determine an actual amount of fuel that was injected based on the difference in pressure identified with the dP identifier. This actual amount of injected fuel may be compared to a desired, or an expected, amount of fuel for the injection event. The difference between the desired fuel delivery and the actual fuel delivery represents a fuel error. This fuel error may be determined by fuel error estimator 36 and output to injector health analyzer 38.

Pump/injector health analyzer 38 may be determined to analyze individual fuel error values and, if desired, track fuel error values over time. The fuel error value may indicate when actual fuel delivery was below the desired fuel delivery by a predetermined minimum delivery threshold, or more. The fuel error value may, in some circumstances, indicate when actual fuel delivery was above the desired fuel delivery by a predetermined maximum delivery threshold, or more.

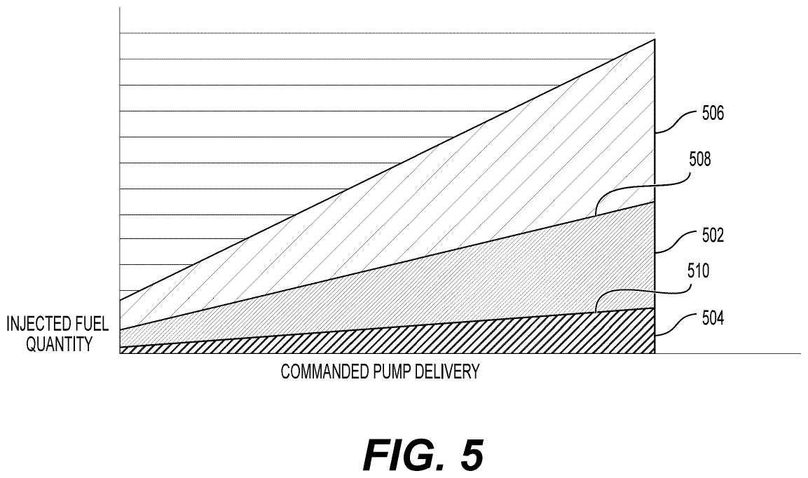

In some examples, the desired fuel delivery may correspond to a command pump delivery value (FIG. 5), the pump delivery being issued to fuel pump 18 to replace fuel in common fuel rail 20 that was injected by fuel injector 22. The minimum delivery threshold and the maximum delivery threshold may be values that are set based on conditions of internal combustion engine 12. For example, the maximum delivery threshold may increase as the commanded pump delivery value increases. The minimum delivery threshold may also increase when the commanded pump delivery value increases.

Pump/injector health analyzer 38 may be configured to identify low health (e.g., wear, element failure, etc.) of a component of the fuel delivery system. Health analyzer 38 may identify a low health condition when the determined actual fuel delivery is below the minimum delivery threshold or above the maximum delivery threshold. When actual fuel delivery is below the minimum delivery threshold, pump/injector health analyzer 38 may determine that health of a first component is low. For example, one fuel injector 22 may have a clogged nozzle, failing injection valve, or other condition causing the fuel injector 22 to have low health. When actual fuel delivery is above the maximum delivery threshold, health analyzer 38 may determine that health of a difference, second, component is low. For example, one fuel injector 22 may have a leaking nozzle, an element (e.g., piston) of fuel pump 18 is failing, etc.

In some aspects, health analyzer 38 may be configured to distinguish a low health condition of fuel pump 18 from a low health condition of injectors 22. For example, a high pressure drop that is measured during injection windows for a group of injectors 22 or for an entirety of injectors 22 may be determined to be a low health condition of pump 18. In contrast, a high pressure drop that occurs for a plurality of injection events for only one injector 22 may be determined to be a low health condition of that injector 22.

ECM 26 may be configured to generate, as outputs 220, pump commands 40. Pump commands 40 may cause fuel pump 18 to supply fuel to common fuel rail 20. Pump commands 40 may further cause the pressure of fuel in common fuel rail 20 to increase to a desired pressure. The desired pressure of fuel within common fuel rail 20 may be set by ECM 26 based on current conditions, such as load on internal combustion engine 12, desired output from internal combustion engine 12, speed of internal combustion engine 12 (e.g., detected with engine speed sensor 28), etc. In particular, pump commands 40 may correspond to the above-described command pump delivery.

Injector commands 42 may cause each fuel injector 22 to inject the desired quantity of fuel. Injector commands 42 may control a start of injection timing and an end of injection timing. Injector commands 42 may include a start of injection command generated during a start of injection window and an end of injection command generated during an end of injection window. In examples where fuel injector 22 is actuated via a solenoid valve, the solenoid may be energized with the start of injection command and de-energized with the end of injection command. The start and end of injection windows may be determined with ECM 26 for each injector 22 on an individual basis. The start of injection window may be determined (e.g., retrieved from one or more maps) based on current engine conditions, requested output, etc. The injection windows may correspond to a range of crank angle values at which a particular injector 22 will begin and end injection, respectively, in response to injector commands 42.

Pump notification 44 and injector notification 46 may be output with injector health analyzer 38 based on the health of fuel pump 18 and fuel injectors 22. Pump notification 44 and injector notification 46 may be generated on a display or as an illumination in a cab of a machine, on a portable device (e.g., a mobile phone), and/or on one or more computing systems (e.g., a supervisory system for managing multiple industrial machines, a system for control of a single industrial machine, etc.). As an example, pump notification 44 may be issued when pump/injector health analyzer 38 identifies low health in a component and determines that the component is fuel pump 18. Injector notification 46 may be issued by pump/injector health analyzer 38 when health analyzer 38 determines that the component with low health is the fuel injector 22.

In some aspects, pump/injector health analyzer 38 may log and monitor the health of components of the fuel system over time, in addition to identifying immediate or sudden low health conditions. In particular, health analyzer 38 may monitor a gradual reduction in health over time, as represented by gradual increases in fuel error values generated with fuel error estimator 36 over time. If desired, health analyzer 38 may determine a rate at which health of component(s) of the fuel system reduces over time, for example based on a rate at which the fuel error values increase over time.

Pump notification 44 may include a display that indicates a current health of fuel pump 18. When fuel pump 18 is operating normally, no notification 44 may be issued or pump notification 44 may indicate (e.g., on a display) that fuel pump 18 is operating normally. Pump notification 44 may indicate a rate at which the health of fuel pump 18 declines (e.g., as an expected timing at which maintenance or repair should be performed on fuel pump 18). Additionally or alternatively, pump notification 44 may indicate when the health of fuel pump 18 is low, immediately in response to determining a low health condition of fuel pump 18 (e.g., based on a single fuel error value deviating from the corresponding delivery threshold, or a minimum number of fuel error values deviating from this delivery threshold).

Injector notification 46 may be output in the same manner described above with respect to pump notification 44, by logging and monitoring the health of injectors 22 over time and/or by identifying immediate low health conditions. As the fuel system of fuel estimation system 10 includes a plurality of injectors 22, injector notification 46 may identify the particular injector 22 and/or location of the particular fuel injector 22 experiencing the low health condition.

### Industrial Applicability

The systems and methods disclosed herein may be applied to any system that supplies pressurized fuel to one or more fuel injectors, such as an industrial machine having an internal combustion engine that allows the machine to perform work, move within a work site, generate electrical power, etc. Suitable industrial machines include, as examples, power generating systems (e.g., gensets), mining machines, hauling machines (e.g., haul trucks for mining, off-highway trucks, etc.), earthmoving machines, paving machines, and others. The analysis of the pressure signal may be performed using an ECM 26 located on the machine, or by an ECM 26 at a remote location (e.g., offsite) for monitoring one or a plurality of machines that each include a fuel system.

FIGS. 3-5 represent signals and analyses that may be performed with fuel delivery determining system 10. In particular, FIG. 3 illustrates a pressure signal 302 and a processed signal 304. Pressure signal 302 corresponds to a series of measurements, forming data points, measured with common rail pressure sensor 24. Processed signal 304 corresponds to a processed signal that was determined based on pressure signal 302. Processed signal 304 may correspond to the above-described phase-offset signal.

In some aspects, pressure signal 302 corresponds to a crank-angle-indexed pressure signal. Each measurement of pressure signal 302 represents magnitude of pressure changes within common fuel rail 20, according to the y-axis FIG. 3. The position of each measurement on the x-axis corresponds to the crank angle measured with engine speed sensor 28. If desired, pressure signal 302 may be filtered to facilitate downstream analysis, FIG. 3 representing a filtered signal 302. In particular, pressure signal 302 may be filtered in a manner that minimizes or eliminates phase distortion. As described above, pressure signal 302 may be filtered with a convolution filter that applies a moving average to raw data from common rail pressure sensor 24 and engine speed sensor 28.

Processed signal 304 may be generated with phase offset analyzer 34 and analyzed with fuel error estimator 36. Processed signal 304 may be generated based on an analysis of pairs of data points of pressure signal 302. In the illustrated example, pressure signal 302 includes a first data point 306, a second data point 308, and a third data point 310. Second data point 308 of signal 302 represents a point of reference. First data point 306 may be 60 degrees of crank angle rotation earlier than second data point 308, and 120 degrees of crank angle rotation earlier than the third data point 310.

Each point of processed signal 304 may be determined by evaluating two data points of signal 302 with respect to a reference point also in signal 302. The two data points may be 60 degrees of crank angle rotation earlier and 60 degrees of crank angle rotation later, respectively from the reference point. Each point of processed signal 304 may be determined by: (i) determining the difference (“a first difference”) between this value (the value of the reference point of pressure signal 302) and the value of the data point that is 60 degrees earlier, (ii) determining the difference (“a second difference”) between the value of the reference point and the value of the data point that is 60 degrees later from the reference point, and (iii) combining the first difference and second difference values (e.g., by addition). The combination of the two difference values results in a pressure change value that corresponds to the crank angle position of the reference point. These three steps (i, ii, iii) may be repeated to determine each point of processed signal 304.

In the example illustrated in FIG. 3, when reference data point 308 is compared to data points 306 and 310, phase offset analyzer 34 determines that the corresponding point of processed signal 304 has approximately the same value as reference point 308. This is determined because the first difference, between point 308 and 306, and the second difference, between point 308 and 310, result in zero when added together. As another example, at another location of signal 302, a second reference point 322 may be compared to a first data point 320 and to a second data point 324. The result of this comparison is a data point 326 of processed signal 304, as the first difference and the second difference in this example, when added together, result in the negative value of shown for point 322.

This process may remove the content (e.g., pressure fluctuations), or influence, of pump 18 in signal 304 according to the repeating (e.g., cyclical) manner at which pump 18 causes changes in pressure (e.g., a pressure pulse that repeats twice for every fuel injection). Once processed signal 304 has been generated, e.g., as described above, fuel error estimator 36 may identify pressure differentials present in processed signal 304. In particular, the dP identifier of fuel error estimator 36 may use predetermined start of injection windows 312 and 316, and end of injection windows 314, and 318. These windows 312, 314, 316, and 318 may correspond to known timings (e.g., crank angles) at which fuel injection begins and ends at a series of regions in processed signal 304.

The dP identifier may identify the maximum pressure value within each start of injection window 312, 316, and the corresponding minimum pressure value within each end of injection window 314, 318. The difference between these values indicates the difference in pressure (“dP”) resulting from a fuel injection event, the dP value being identified with the pressure fluctuations of fuel pump 18 being removed or reduced.

In FIG. 3, window 312 may correspond to a start of injection window for a first fuel injector 22. Injection window 314 may correspond to the end of injection window for the first injector 22. Start and end of injection windows 316 and 318 may correspond to a second injector. Subsequent injection windows (not shown) are determined for each subsequent injector 22, such that dP values determined for each pair of injection windows is associated with a particular fuel injector 22.

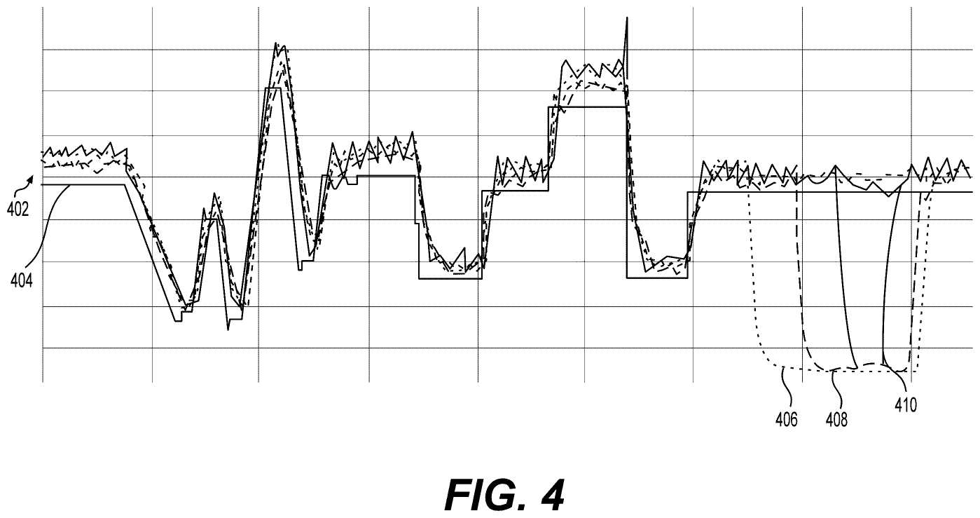

FIG. 4 illustrates six actual fuel injection quantity waveforms 402. Each fuel injection waveform 402 is determined with the above-described dP values. FIG. 4 also illustrates a desired fuel injection quantity 404 that corresponds to the commanded or desired fuel injection quantity. In FIG. 4, desired fuel injection quantity 404 is offset slightly below waveforms 402 to facilitate visual distinguish desired fuel injection quantity 404 from six actual fuel injection quantity waveforms 402 as presented in FIG. 4, these actual fuel injection quantity waveforms 402 being determined after removing pressure fluctuations from pump 18. Desired fuel injection quantity 404 generally aligns with six actual fuel injection quantity waveforms 402 when fuel pump 18 and fuel injector 22 are both in a healthy condition.

In the example illustrated in FIG. 4, each of the fuel injectors generally injects the expected quantity of fuel. Towards the end of the illustrated plot, three fuel injector waveforms indicate a first failure 406, a second failure 408, and a third failure 410. Failures 406, 408, and 410 indicate actual injection quantities that drop below desired fuel injection quantity 404. These drops in actual injection quantities correspond to areas of processed signal 304 (FIG. 3) that are flat, such as the areas immediately before and immediately following second data point 308.

While first failure 406, second failure 408, and third failure 410 each represent a low, or zero, amount of fuel injected for a period of time, failures may also occur when the determined actual injection quantity exceeds desired fuel injection quantity 404, as described above.

FIG. 5 is a chart representing example determinations for identifying the health of fuel pump 18 and fuel injectors 22. A healthy condition region 502 represents acceptable operation of fuel pump 18 and fuel injector 22. In healthy region 502, the commanded delivery of pump 18 generally corresponds to the actual injected fuel quantity. Healthy region 502 may be defined between a maximum delivery threshold 508 and a minimum delivery threshold 510. As described above, maximum delivery threshold 508 may generally increase as the commanded pump delivery increases. Minimum delivery threshold 510 may also generally increase with increases in the commanded pump delivery.

When the actual injected fuel quantity falls below minimum delivery threshold 510, injector health analyzer 38 may determine that the health of fuel pump 18, fuel injector 22, or both, is low. As described above, pump/injector health analyzer 38 may determine that fuel pump 18 has failed or is experiencing a fault (e.g., a piston of fuel pump 18 is failing to pump fuel). This fault in fuel pump 18 may be indicated via pump notification 44. Additionally or alternatively, pump/injector health analyzer 38 may determine that a particular fuel injector 22 has failed or is experiencing a fault (e.g., the nozzle of fuel injector 22 is clogged, a valve of fuel injector 22 is stuck in a closed position, etc.). This fault in injector 22 may be indicated via injector notification 46.

When the actual injected fuel quantity raises above maximum delivery threshold 508, pump/injector health analyzer 38 may determine that the health of fuel injector 22 is low. As described above, health analyzer 38 may determine that fuel injector 22 has failed or is experiencing a fault (e.g., a nozzle of fuel injector 22 is leaking fuel, a valve of injector 22 is stuck in an open position, etc.). This fault in fuel injector 22 may be indicated via injector notification 46.

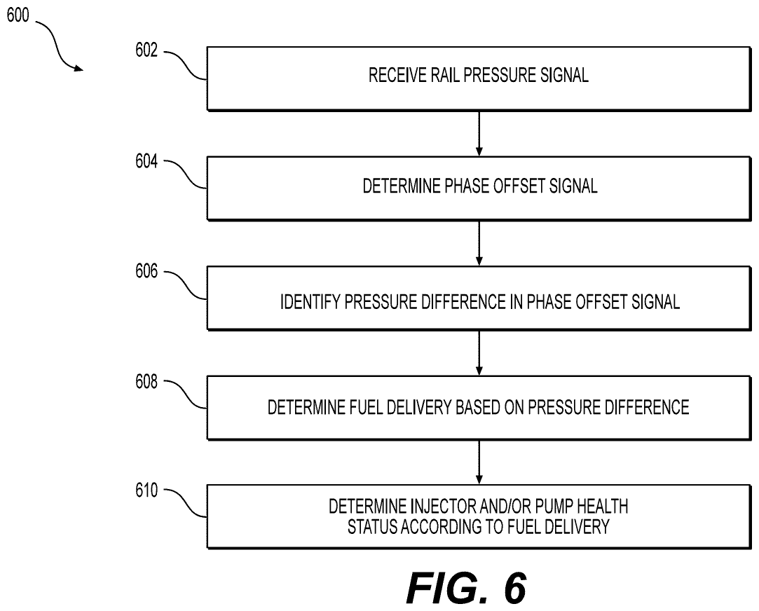

FIG. 6 is a flowchart showing a method 600 for determining fuel delivery, according to aspects of the disclosure. A step 602 of method 600 may include receiving a rail pressure signal. In particular, step 602 may include receiving signals from common rail pressure sensor 24 with ECM 26. The rail pressure signal received in step 602 may correspond to pressure signal 302 (FIG. 3).

A step 604 may include determining a phase offset signal. This signal may be determined based on the rail pressure signal received in step 602. In particular, step 604 may include determining processed signal 304 with phase offset analyzer 34. In some aspects, step 604 may include generating signals other than a phase offset signal. In particular, step 604 may include generating a signal that reduces or eliminates content of fuel pump 18 within the rail pressure signal received in step 602.

In a step 606, fuel error estimator 36 may identify one or multiple pressure differences in the phase offset signal or other signal determined in step 604. Step 606 may include identifying pressure differences present among start of injection windows 312, 316, and end of injection windows 314, 318, as described above with respect to FIG. 3.

In a step 608, fuel error estimator 36 may determine an actual amount of fuel delivery based on pressure difference(s) determined in step 606. Step 608 may include estimating fuel with the fuel delivery estimator of fuel error estimator 36. The fuel delivery estimate may be determined for each individual injector 22 and may be monitored over time.

A step 610 may include determining the health of a component of the fuel delivery system for engine 12, such as a health of fuel pump 18 and/or fuel injector 22, as described above. Step 610 may include logging the health of one or more components over time.

Additionally or alternatively, step 610 may include generating one or more notifications, such as pump notification 44 and injector notification 46, as described above.

The disclosed system and method may be configured to monitor the health of fuel pump 18 and fuel injector 22 over time. In particular, the system and method may be configured to identify low health or component failures based on pressure changes that are identified with common rail pressure sensor 24. The content of fuel pump 18, such as pressure fluctuations due to pump strokes, may be reduced or eliminated by separating pump strokes from injection events. In some configurations, errors in the quantity of fuel delivery may be obtained with an unobtrusive monitoring system that identifies potential failures without specialized test equipment.

It will be apparent to those skilled in the art that various modifications and variations can be made to the disclosed method and system without departing from the scope of the disclosure. Other embodiments of the method and system will be apparent to those skilled in the art from consideration of the specification and practice of the apparatus and system disclosed herein. It is intended that the specification and examples be considered as exemplary only, with a true scope of the disclosure being indicated by the following claims and their equivalents.

1. A system for determining fuel delivery, the system comprising:
an internal combustion engine having a plurality of cylinders;
a plurality of fuel injectors configured to inject fuel for combustion in the cylinders;
a fuel rail configured to provide the fuel to the plurality of fuel injectors;
a fuel pump configured to pressurize the fuel provided to the fuel rail;
a pressure sensor configured to detect a pressure of the fuel within the fuel rail; and
a controller configured to:
receive a pressure signal that indicates the pressure of the fuel detected with the pressure sensor, the pressure signal including pressure fluctuations caused by the fuel pump,
determine a quantity of the fuel injected by one or more fuel injectors of the plurality of fuel injectors, wherein the determination includes removing or reducing at least some of the pressure fluctuations caused by the fuel pump from the pressure signal, and
identify a health of a fuel injector of the plurality of fuel injectors, or of the fuel pump, based on the quantity of fuel, the quantity of fuel corresponding to a portion of the pressure signal that indicates a substantially flat pressure change after the at least some of the pressure fluctuations are removed or reduced.

2. The system of claim 1, wherein the controller is further configured to:
determine a processed pressure signal that removes or reduces at least some of the pressure fluctuations caused by the fuel pump in the processed pressure signal, and
identify a change in pressure indicated in the processed pressure signal, the change in pressure corresponding to an injection of fuel.

3. The system of claim 1, wherein the pressure fluctuations caused by the fuel pump are a result of a periodic fuel pressurization caused by the fuel pump.

4. The system of claim 1, wherein the controller is further configured to identify a fuel injector with low health based on the determined quantity of fuel injected by one or more of the plurality of fuel injectors.

5. The system of claim 1, wherein the controller is further configured to identify a failure in the fuel pump and a failure in the one or more fuel injectors.

6. The system of claim 1, wherein the controller is configured to identify a pump having low health based on an increase in a change in pressure in a processed signal generated by removing or reducing at least some of the pressure fluctuations caused by the fuel pump from the pressure signal.

7. The system of claim 1, wherein the controller is configured to identify a failed pump element based on a decrease in a change in pressure in a processed signal generated by removing or reducing at least some of the pressure fluctuations caused by the fuel pump from the pressure signal.

8. A system for determining fuel delivery, the system comprising:
a fuel pressure sensor configured to output a pressure signal that indicates a pressure of fuel within a fuel rail; and
a controller configured to:
determine a desired amount of fuel to be injected by a first fuel injector,
receive the pressure signal from the fuel pressure sensor, the pressure signal including pressure fluctuations caused by a fuel pump.
identify a change in pressure indicated in the pressure signal, the change in pressure corresponding to an actual amount of fuel injected by the first fuel injector,
compare the actual amount of fuel injected by the first fuel injector to the desired amount of fuel to be injected by the first fuel injector, and
identify failure of the first fuel injector based on the comparison and when the change in pressure is substantially flat after at least some of the pressure fluctuations caused by the fuel pump are removed from the pressure signal.

9. The system of claim 8, further including an engine speed sensor configured to generate an engine speed signal, wherein the controller is further configured to identify the change in pressure based on a start of injection window and an end of injection window, the start of injection window and the end of injection window being determined based on the engine speed signal.

10. The system of claim 8, wherein the controller is further configured to:
determine a desired amount of fuel to be injected by a second fuel injector,
identify a change in pressure indicated in the pressure signal, the change in pressure corresponding to an actual amount of fuel injected by the second fuel injector between a start of injection window and an end of injection window,
compare the actual amount of fuel injected by the second fuel injector to the desired amount of fuel to be injected by the second fuel injector, and
identify a health of the second fuel injector.

11. The system of claim 10, wherein the controller is further configured to identify a failure of the first fuel injector when the comparison determines that the actual amount of fuel is below the desired amount of fuel.

12. The system of claim 10, wherein the controller is further configured to identify a failure of the fuel pump based on a pressure drop indicated by the pressure signal.

13. A method for determining fuel delivery, the method comprising:
receiving, from a pressure sensor, a pressure signal that indicates pressure of fuel within a fuel rail;
filtering the pressure signal to generate a filtered signal;
determining, based on the filtered signal, a processed pressure signal that reduces or eliminates at least some pressure fluctuations in the processed pressure signal, the pressure fluctuations being introduced by a fuel pump;
identifying a change in pressure indicated in the processed pressure signal, the change in pressure corresponding to an injection of fuel; and
determining a quantity of fuel injected by one or more fuel injectors of a plurality of fuel injectors based on the identified change in pressure.

14. The method of claim 13, wherein the processed pressure signal is a phase-offset signal generated by comparing points of the pressure signal with different phases to each other.

15. The method of claim 13, further including reducing at least some content of a periodic fuel pressurization that was introduced in the pressure signal by the fuel pump.

16. The method of claim 13, further including identifying a failed fuel injector based on the determined quantity of fuel injected by one or more of the plurality of fuel injectors.

17. The method of claim 13, further including identifying a failed pump element based on an increase in the change in pressure indicated in the processed pressure signal.

18. The method of claim 13, further including identifying a failed pump element based on a decrease in the change in pressure indicated in the processed pressure signal.

19. The method of claim 13, further including:
comparing the determined quantity of fuel to a desired amount of fuel to be injected; and
identifying a failure of a fuel injector when the comparison determines that the determined quantity of fuel is less than the desired amount of fuel.

20. The method of claim 13, further including:
comparing the determined quantity of fuel injected for a plurality of fuel injections to a desired amount of fuel to be injected for the plurality of fuel injections; and
identifying a failure of a fuel pump when the comparison determines that the determined quantity of fuel is above the desired amount of fuel.
